(19) United States
(12) Patent Application Publication
(10) Pub. No.: US 2025/0343820 A1
(43) Pub. Date: Nov. 6, 2025

(54) Secure Configuration Change Approvals with Shamir Secret Sharing

(71) Applicant: Dell Products L.P., Round Rock, TX (US)

(72) Inventors: Anthony A. Critelli, Rochester, NY (US); Jeremy C. Phelps, Venice, FL (US); Jeroen Mackenbach, Roosendaal (NL)

(73) Assignee: Dell Products L.P., Round Rock, TX (US)

(21) Appl. No.: 18/653,732

(22) Filed: May 2, 2024

(51) Int. Cl. H04L 9/40

(52) U.S. Cl. CPC H04L 63/20

(57) ABSTRACT

Embodiments are directed to secure configuration change at an edge device. A method includes receiving configuration change data at a device, the configuration change data associated with an encrypted authentication key; sending the configuration change data to a plurality of peer devices; receiving secret shares from a quorum of the peer devices, wherein each of the quorum of peer devices sends its respective secret share if it determines that the configuration change data complies with a configuration policy; constructing an decryption key using a quorum of the secret shares; decrypting the authentication key using the decryption key; and applying the authentication key to install the configuration change on the device. The method may further comprise determining, by the device, whether the configuration change data complies with the configuration policy; and constructing the encryption key using the quorum of the secret shares and a secret share stored on the device.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination.

IHSs can be used in a distributed environment as edge devices. Edge devices may be vulnerable to attack due to being in a remote location and/or a lack of physical security. Edge devices often service critical workloads. The edge devices may run autonomously without network connectivity to a central control plane for an extended period of time. Example edge devices include applications running in a retail store, such as point of sale device, a gateway, a compute or storage device not operating in a datacenter, remote industrial sensor and monitoring equipment, or deployed telecommunications equipment. In these architectures, it is important to protect the remote edge devices from compromise. Under the control of an attacker, a compromised edge device may apply configuration changes that violate enterprise policy and that allow malicious actions on the network.

### SUMMARY

Embodiments are directed to secure configuration change at an edge device. A method includes receiving configuration change data at a device, the configuration change data associated with an encrypted authentication key; sending the configuration change data to a plurality of peer devices; receiving secret shares from a quorum of the peer devices, wherein each of the quorum of peer devices sends its respective secret share if it determines that the configuration change data complies with a configuration policy; constructing an decryption key using a quorum of the secret shares; decrypting the authentication key using the decryption key; and applying the authentication key to install the configuration change on the device. The method may further comprise determining, by the device, whether the configuration change data complies with the configuration policy; and constructing the encryption key using the quorum of the secret shares and a secret share stored on the device.

### BRIEF DESCRIPTION OF THE DRAWINGS

Having thus described the invention in general terms, reference will now be made to the accompanying drawings, which are not necessarily drawn to scale, and wherein:

FIG. 1 illustrates a highly distributed system having a plurality of edge devices that communicate with a remote, central orchestrator via a network.

FIG. 2 illustrates the central orchestrator sending configuration information to an edge device.

FIG. 3 illustrates the edge device distributing the configuration information to peer devices.

FIG. 4 illustrates the peer edge devices reviewing the configuration information in view of a configuration policy.

FIG. 5 illustrates some peer edge devices approving the configuration information.

FIG. 6 illustrates certain peer edge devices sending individual shares of a shared secret key to the requester device.

FIG. 7 illustrates an example of Information Handling System (IHS) configured to implement secure configuration change approvals with Shamir Secret Sharing (SSS).

FIG. 8 is a flowchart illustrating an example process for secure configuration change.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The embodiments disclosed herein provide systems and methods to increase resiliency of distributed edge environments against malicious configuration. In one embodiment, sensitive authentication material that is needed to make a configuration change is distributed among several edge devices. Each edge device must agree to a configuration change before the change can be applied to any individual edge device. Edge devices in distributed environments are vulnerable to physical attack and must often operate without connectivity to a central control plane for an extended period of time. This makes the edge devices vulnerable to compromise where an attacker may try to reconfigure these systems in undesirable ways. Distributing a configuration decision among peer edge devices makes it cryptographically impossible to enact the configuration change without a quorum, which increases the resiliency of edge systems to avoid the types of compromises noted above.

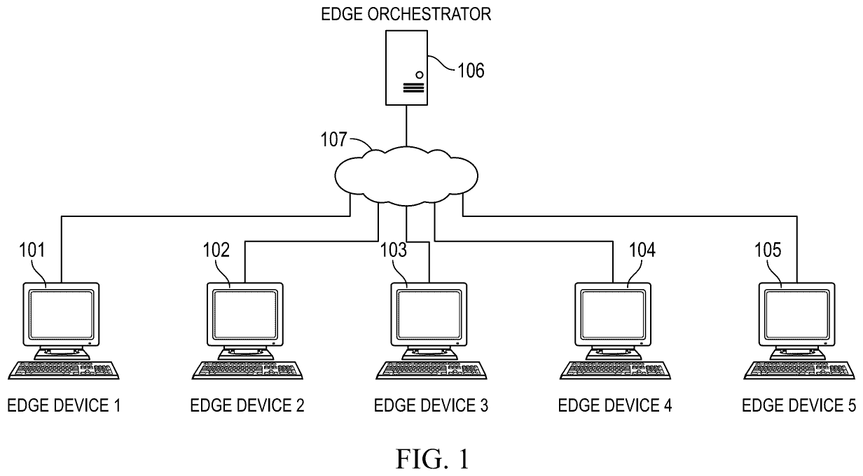

FIG. 1 illustrates a highly distributed system 100 having a plurality of edge devices 101-105 that communicate with a remote, central orchestrator 106 via a network 107. Central orchestrator controls the edge devices 101-105. Network 107 may be an intranet, the Internet, or any other public or private wired or wireless network. Edge devices 101-105 and central orchestrator 106 may be Information Handling Systems (IHSs). In various embodiments, edge devices 101-105 may be customer premises equipment, processor-based devices (e.g., systems executing applications on a Central Processing Unit (CPU), Graphic Processing Unit (GPU), or specialized processers such as FPGAs and ASICs), servers, routers, switches, firewalls, sensors, Internet of Things (IoT) devices.

Distributed edge environments demand secure configuration of edge devices 101-105. In the context of configuration changes, two important components of an edge security strategy are: authorization and policy. Authorization ensures that changes are only made by entities that are supposed to make changes. Policy ensures that a proposed configuration meets an organization's rules and constraints before a configuration change is applied to a system.

Traditional systems evaluate policy and push configurations from a central location, such as edge orchestrator 106. Centralized orchestration and configuration is a requirement in highly distributed edge environments. Policy evaluation is typically performed by a centralized control plane before a configuration is pushed to end devices. For example, a user may change a configuration parameter from a centralized orchestrator, the orchestrator evaluates policy against the change, and then the orchestrator pushes the change to remote devices. In this situation, the central configuration management system and the configured device become single points of security failure. A malicious entity could gain access to the configured device and apply forbidden configuration without the knowledge of the central configuration management system.

In architectures such as shown in FIG. 1, it is important to protect the remote devices 101-105 from compromise. Embodiments disclosed herein focus on methods that enable authorized policy evaluation in remote environments. This method decreases the likelihood that a compromised device can apply a configuration change that violates an organization's policy constraints.

The present systems and methods increase the resiliency of distributed edge environments with respect to malicious configurations. Embodiments are directed to distributing sensitive authentication material, such as information required to make a configuration change, among several edge devices. Each edge device must agree to the configuration change before it can be applied. The Shamir Secret Sharing (SSS) is used in a novel way. SSS is an algorithm that breaks up a secret into multiple shares then distributes these shares among peers. The secret cannot be retrieved unless a configurable quorum agrees to share their individual piece of the secret.

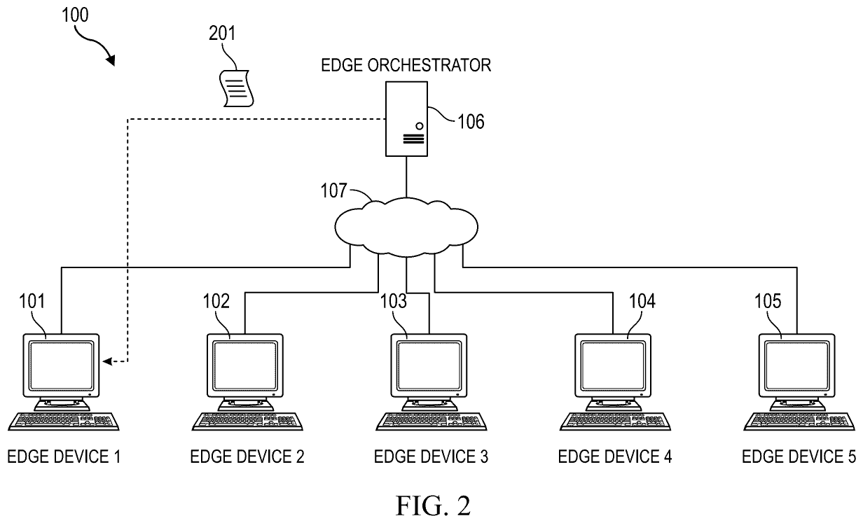

In FIG. 2, the central orchestrator 106 sends configuration information 201 to edge device 101. In a traditional architecture, edge device 101 would immediately apply the configuration 201 to the local system. This typically involves escalating privileges to an administrative user to apply the configuration change. However, in an example embodiment, edge device 101 is not capable of applying the configuration because it lacks required authentication information. The authentication material that is required to apply configuration 201, such as a password or a service token, is encrypted using a shared key. Shares of the key are distributed among the edge devices 101-105 using SSS shares. Typically, the SSS shares would be distributed to edge devices 101-105 prior to, and independently of, the distribution of configuration information 201. The configuration information may be, for example, updates to an application running on edge device 101, a new application assigned to run on edge device 101, an operating system update for edge device 101, a firmware change for edge device 101, new hardware or a hardware configuration change on edge device 101, or authentication credentials required by edge device 101 to run an application, access a website or database, or to confirm whether remote access into edge device 101 is approved.

The shared key is a secret value S. A defined minimum number of shares are needed to find out the secret value. The secret can be divided into any number of shares. The shares are distributed among participants that hold parts of the secret. For example, N shares may be created and distributed to N participants so that each participant has a unique share. A minimum number of shares must be known to reconstruct the secret. For example, the minimum number of shares is set to require k shares to reconstruct the secret, where k≤N (i.e., the required number of shares to reconstruct the secret may be some or all of the shares). Edge device 101 will already have one share of the secret in most cases. So, only k−1 other shares are required from the other edge devices 102-105.

In the example used in FIGS. 1-6, agreement by a majority (i.e., simple or super majority) or a quorum (i.e., a minimum number of shares that must be present to conduct business) of the edge devices is required to reconstruct the secret and thereby install the configuration change. There are five edge devices 101-105 that hold the shares, so a simple majority of the devices is any combination of at least three edge devices (i.e., k=3 in this example). In another example, a quorum of edge devices 102-105 are required to provide shares, such as three of the four peer edge devices 102-105. In other examples, the minimum number of shares required may be any number or proportion of participating edge devices.

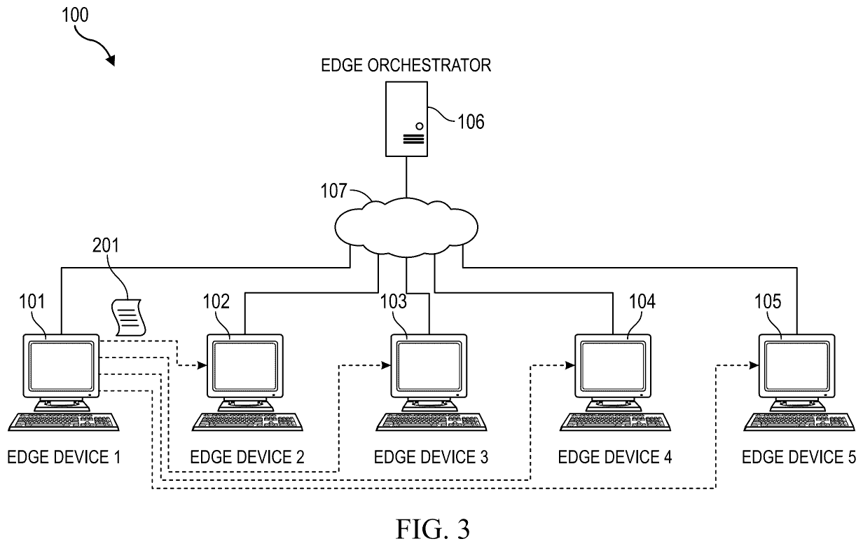

In FIG. 3, edge device 101 distributes the configuration 201 to its peer devices 102-105. To apply the configuration, edge device 101 must receive a quorum of responses from devices 102-105. Each peer device 102-105 contains knowledge of the configuration policy for the environment. Each peer 102-105 evaluates the proposed configuration change 201 against their understanding of the configuration policy.

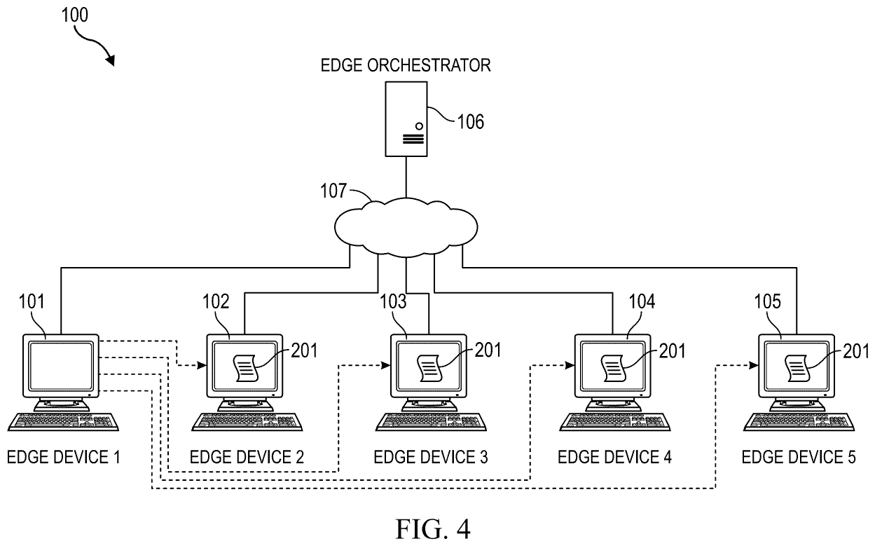

In FIG. 4, the edge devices 102-105 review configuration 201. For example, each peer edge device 102-105 may determine whether it would accept the proposed configuration change 201 to itself. If an edge device would accept the configuration change under the current configuration policy, then that edge device will send its share to edge device 101. A quorum of edge devices 102-105 must approve configuration 201 for it to take effect on device 101. SSS supports a configurable quorum. This quorum may require a single device's approval, or the quorum could require the approval of all edge devices.

Once an edge device has approved the proposed configuration change 201, that device sends its portion of the SSS key to the requestor (i.e., device 101). By splitting the algorithm for encrypting authentication material across multiple endpoints, one device cannot expose the system to attack by installing a malicious configuration change. Instead, a quorum of peer edge devices determine whether a configuration change is valid. It is less likely that a quorum of edge devices will be compromised. An attacker would effectively need to have comprised a quorum number of edge devices to implement a malicious configuration change.

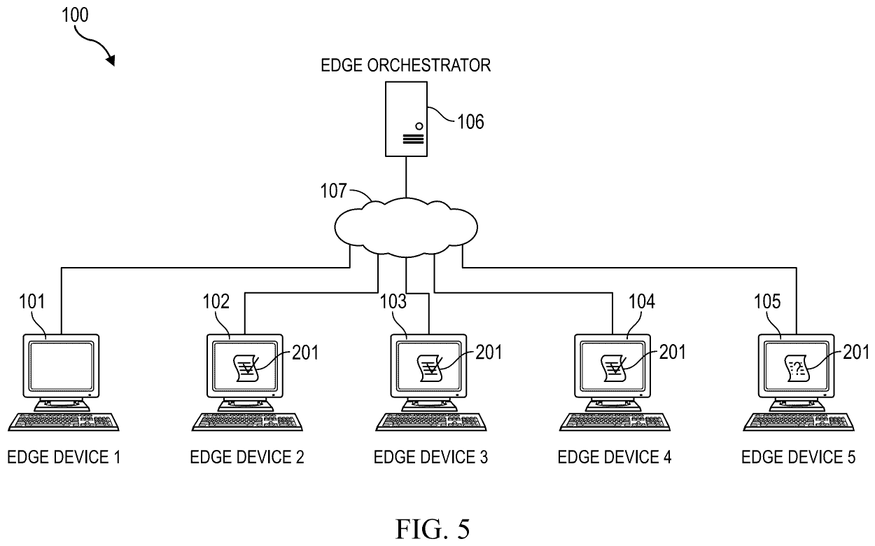

In the illustrated example, a quorum requires at least three of the peer edge devices 102-105 to approve the configuration change 201. In FIG. 5, edge devices 102, 103, and 104 have approved the configuration change 201 (i.e., those devices determined that the proposed configuration meets the current configuration policy). Edge device 105 is unable to approve the configuration change 201 or may still be evaluating the configuration 201. As each edge device 101-104 approves the configuration 201, it sends its portion of the SSS key to the requestor device 101.

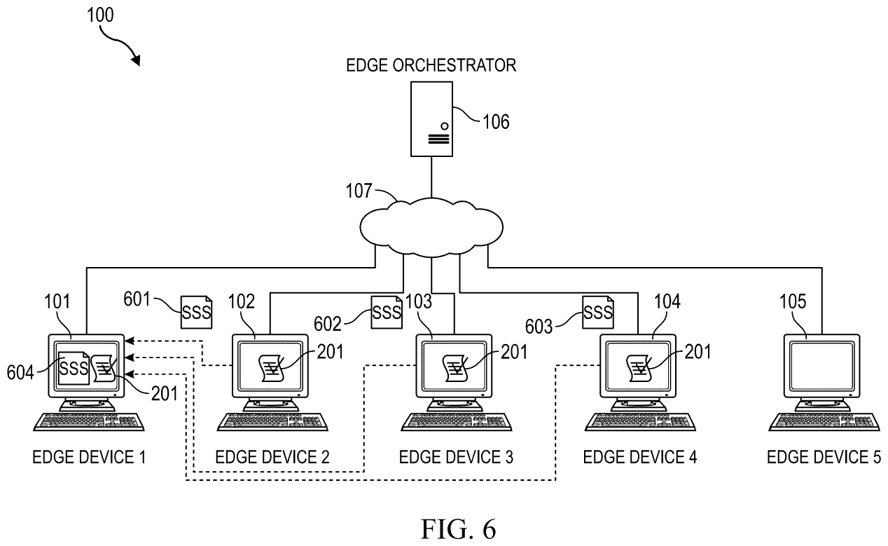

FIG. 6 illustrates edge devices 102-104 sending their individual shares of the SSS key to requester device 101. Once edge device 101 has the three SSS shares 601-603 (i.e., a quorum), then it has sufficient information reconstruct the shared key. Edge device 101 may perform its own evaluation of configuration change 201 and determine whether the configuration change 201 conforms with the configuration policy. Typically, edge device 101 would only move forward with reconstructing the shared key if policy requirements are met. In that case, edge device 101 also likely has its own SSS share 604 that can be used in the reconstruction.

Edge device 101 uses the appropriate number of SSS shares 601-604 (i.e., k shares) to reconstruct the shared key. Once the shared key is obtained, the shared key can then be used to decrypt the authentication material that is required to apply configuration 201. This authentication material may be a password, service token, or some other value that must be provided to enact a change on the system. Upon successful decryption of the configuration key, the device can apply the proposed configuration change 201.

In one embodiment, the systems and methods disclosed herein may be used, for example, with automation systems that configure remote Linux systems. Such systems often rely on privilege escalation techniques, such as using the Linux “sudo” utility, to perform protected system configuration. A process for secure configuration change approvals with Shamir Secret Sharing as described herein could be used to protect the authentication material, such as a password or private key, needed to escalate privileges.

In another example embodiment, a secure configuration change process using Shamir Secret Sharing may be applied to a Kubernetes cluster, which is a collection of nodes running workloads. Kubernetes provides a distributed control plane for containerized workloads. The extensibility of the Kubernetes control plane allows it to manage many other types of resources. The control plane is extended by implementing “controllers” to watch for drift between the desired state of a cluster and the actual, running state of the cluster. Controllers ultimately handle requests for configuration changes. Controllers typically run multiple replicas across a cluster for high availability. They authenticate with a Kubernetes API using a certificate or service account token. The process for secure configuration change approvals with Shamir Secret Sharing could be used to encrypt this authentication material using SSS. This would prevent a single member of the controller cluster from applying a change to the Kubernetes environment without a quorum of other members.

Configuration of remote edge applications usually involves providing authentication material, such as a password, before a configuration can be performed. The process for secure configuration change approvals with Shamir Secret Sharing could be used to encrypt the password and distribute the encryption key among peers using SSS. The configuration change being applied to the edge device may be, for example, a new application deployment, a telemetry request, or any other API request.

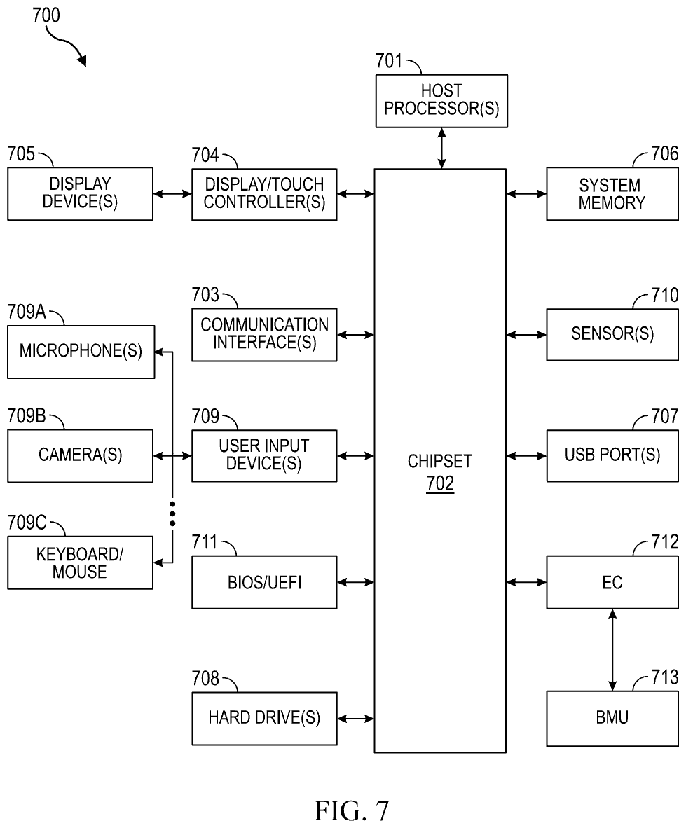

FIG. 7 shows an example of an Information Handling System (IHS) 700 configured to implement systems and methods described herein for secure configuration change approvals with Shamir Secret Sharing. IHS 700 may be used as edge devices 101105 or edge orchestrator 106 (FIG. 1), for example.

FIG. 7 is a block diagram of components of IHS 700. As depicted, IHS 700 includes host processor(s) 701. In various embodiments, IHS 700 may be a single-processor system, or a multi-processor system including two or more processors. Host processor(s) 701 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 700 includes chipset 702 coupled to host processor(s) 701. Chipset 702 may provide host processor(s) 701 with access to several resources. In some cases, chipset 702 may utilize a QuickPath Interconnect (QPI) bus to communicate with host processor(s) 701. Chipset 702 may also be coupled to communication interface(s) 703 to enable communications between IHS 700 and various wired and/or wireless networks, such as Ethernet, WiFi, BT, cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 703 may be used to communicate with peripheral devices (e.g., BT speakers, microphones, headsets, etc.). Moreover, communication interface(s) 703 may be coupled to chipset 702 via a Peripheral Component Interconnect Express (PCIe) bus, or the like.

Chipset 702 may be coupled to display and/or touchscreen controller(s) 704, which may include one or more Graphics Processor Units (GPUs) on a graphics bus, such as an Accelerated Graphics Port (AGP) or PCIe bus. As shown, display controller(s) 704 provide video or display signals to one or more display device(s) 705.

Display device(s) 705 may include Liquid Crystal Display (LCD), Light Emitting Diode (LED), organic LED (OLED), or other thin film display technologies. Display device(s) 705 may include a plurality of pixels arranged in a matrix, configured to display visual information, such as text, two-dimensional images, video, three-dimensional images, etc. In some cases, display device(s) 705 may be provided as a single continuous display, rather than two discrete displays.

Chipset 702 may provide host processor(s) 701 and/or display controller(s) 704 with access to system memory 706. In various embodiments, system memory 706 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 702 may also provide host processor(s) 701 with access to one or more Universal Serial Bus (USB) ports/controllers 707, to which one or more peripheral devices may be coupled (e.g., integrated or external webcams, microphones, speakers, etc.).

Chipset 702 may further provide host processor(s) 701 with access to one or more hard disk drives, solid-state drives, optical drives, or other removable-media drives 708.

Chipset 702 may also provide access to one or more user input devices 709, for example, using a super I/O controller or the like. Examples of user input devices 709 include, but are not limited to, microphone(s) 709a, camera(s) 709b, and keyboard/mouse 709c. Other user input devices 709 may include a touchpad, stylus or active pen, totem, etc. Each user input device 709 may include a respective controller (e.g., a touchpad may have its own touchpad controller) that interfaces with chipset 702 through a wired or wireless connection (e.g., via communication interfaces(s) 703).

In some cases, chipset 702 may also provide access to one or more user output devices (e.g., video projectors, paper printers, 3D printers, loudspeakers, audio headsets, Virtual/Augmented Reality (VR/AR) devices, etc.).

In certain embodiments, chipset 702 may further provide an interface for communications with one or more hardware sensors 710. Sensors 710 may be disposed on or within the chassis of IHS 700, or otherwise coupled to IHS 700, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

BIOS/UEFI 711 is coupled to chipset 702. UEFI was designed as a successor to BIOS, and many modern IHSs utilize UEFI in addition to or instead of a BIOS. Accordingly, BIOS/UEFI 711 is intended to also encompass a UEFI component. BIOS/UEFI 711 provides an abstraction layer that allows the OS to interface with certain hardware components that are utilized by IHS 700.

Upon booting of IHS 700, host processor(s) 701 may utilize program instructions of BIOS 711 to initialize and test hardware components coupled to IHS 700, and to load a host OS for use by IHS 700. Via the hardware abstraction layer provided by BIOS/UEFI 711, software stored in system memory 706 and executed by host processor(s) 701 can interface with I/O devices coupled to IHS 700.

Embedded Controller (EC) 712 (sometimes referred to as a Baseboard Management Controller or “BMC”) includes a microcontroller unit or processing core dedicated to handling selected IHS operations not ordinarily handled by host processor(s) 701.

Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes or “LEDs” (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 700, EC 712 may be made operational from the very start of each power reset, before other devices are fully running or powered on. As such, EC 712 may be responsible for interfacing with a power adapter to manage the power consumption of IHS 700. These operations may be utilized to determine the power status of IHS 700, such as whether IHS 700 is operating from battery power or is plugged into an AC power source. Firmware instructions utilized by EC 712 may be used to manage other core operations of IHS 700 (e.g., turbo modes, maximum operating clock frequencies of certain components, etc.).

In some cases, EC 712 may implement operations for detecting certain changes to the physical configuration or posture of IHS 700 and managing other devices in different configurations of IHS 700. For instance, when IHS 700 as a 2-in-1 laptop/tablet form factor, EC 712 may receive inputs from a lid position or hinge angle sensor 710, and it may use those inputs to determine: whether the two sides of IHS 700 have been latched together to a closed position or a tablet position, the magnitude of a hinge or lid angle, etc. In response to these changes, the EC may enable or disable certain features of IHS 700 (e.g., front or rear facing camera, etc.).

In some implementations, EC 712 may be installed as a Trusted Execution Environment (TEE) component to the motherboard of IHS 700. Additionally, or alternatively, EC 712 may be further configured to calculate hashes or signatures that uniquely identify individual components of IHS 700. In such scenarios, EC 712 may calculate a hash value based on the configuration of a hardware and/or software component coupled to IHS 700. For instance, EC 712 may calculate a hash value based on all firmware and other code or settings stored in an onboard memory of a hardware component.

Hash values may be calculated as part of a trusted process of manufacturing IHS 700 and may be maintained in secure storage as a reference signature. EC 712 may later recalculate the hash value for a component may compare it against the reference hash value to determine if any modifications have been made to the component, thus indicating that the component has been compromised. As such, EC 712 may validate the integrity of hardware and software components installed in IHS 700.

In addition, EC 712 may provide an Out-of-Band communication channel that allows an Information Technology Decision Maker (ITDM) or Original Equipment Manufacturer (OEM) to manage IHS 700's various settings and configurations, for example, by issuing OOB commands.

In various embodiments, IHS 700 may be coupled to an external power source through an AC adapter, power brick, or the like. The AC adapter may be removably coupled to a battery charge controller to provide IHS 700 with a source of DC power provided by battery cells of a battery system in the form of a battery pack (e.g., a lithium ion or “Li-ion” battery pack, or a nickel metal hydride or “NiMH” battery pack including one or more rechargeable batteries).

Battery Management Unit (BMU) 713 may be coupled to EC 712 and it may include, for example, an Analog Front End (AFE), storage (e.g., non-volatile memory), and a microcontroller. In some cases, BMU 713 may be configured to collect and store information, and to provide that information to other IHS components.

Examples of information collectible by BMU 713 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc.

Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 700 may not include all the components shown in FIG. 7. Furthermore, some components that are represented as separate components in FIG. 7 may instead be integrated with other components, such that all or a portion of the operations executed by the illustrated components may instead be executed by the integrated component.

For example, in various embodiments described herein, host processor(s) 701 and/or other components shown in FIG. 7 (e.g., chipset 702, display controller(s) 704, communication interface(s) 703, EC 712, etc.) may be replaced by other devices. As such, IHS 700 may assume different form factors including, but not limited to: servers, workstations, desktops, laptops, appliances, video game consoles, tablets, smartphones, etc.

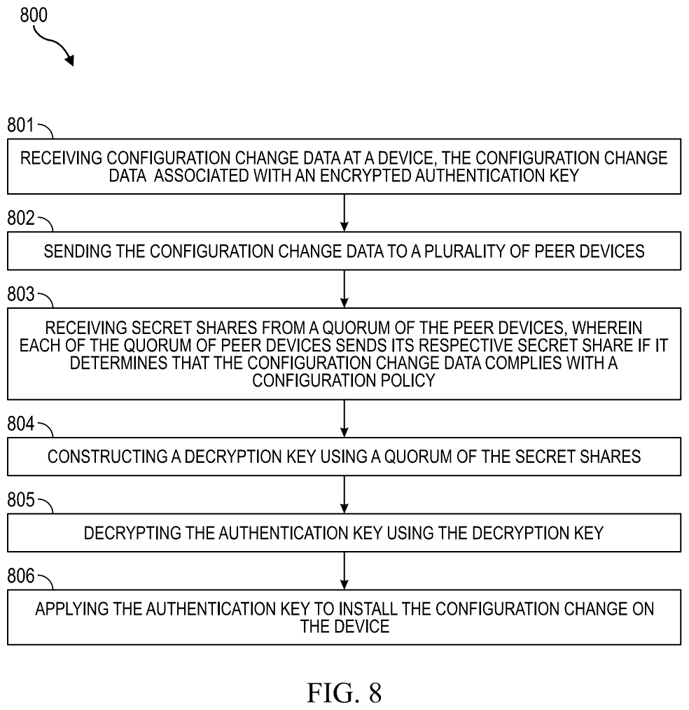

FIG. 8 is a flowchart illustrating an example process 800 for secure configuration change. At 801, configuration change data is received at a device. The configuration change data associated with an encrypted authentication key. At 802, the configuration change data is sent to a plurality of peer devices. The device and the peer devices may be edge devices, and the configuration change data may be received from a central control plane. At 803, secret shares are received from a quorum of the peer devices. Each of the quorum of peer devices sends its respective secret share if it determines that the configuration change data complies with a configuration policy.

At 804, a decryption key is constructed using a quorum of the secret shares. The encryption key may be constructed from the secret shares using a Shamir's secret sharing algorithm. The quorum of the peer devices may be a simple majority or super majority of the peer devices, a fixed number or percentage of the peer devices, or all of the peer devices.

At 805, the authentication key is decrypted using the decryption key. At 806, the authentication key is applied to install the configuration change on the device. The configuration change data may be, for example, an application update, a new application, an operating system update, a firmware change, a hardware change, or authentication credentials for the device.

The device may also determine locally whether the configuration change data complies with the configuration policy. If the device locally determines that the configuration change data complies with the configuration policy, then the device constructs the encryption key using the quorum of the secret shares along with a secret share stored on the device itself.

In an illustrative, non-limiting embodiment, a method for secure configuration change comprises receiving configuration change data at a device, the configuration change data associated with an encrypted authentication key; sending the configuration change data to a plurality of peer devices; receiving secret shares from a quorum of the peer devices, wherein each of the quorum of peer devices sends its respective secret share if it determines that the configuration change data complies with a configuration policy; constructing an decryption key using a quorum of the secret shares; decrypting the authentication key using the decryption key; and applying the authentication key to install the configuration change on the device. The method may further comprise determining, by the device, whether the configuration change data complies with the configuration policy; and constructing the encryption key using the quorum of the secret shares and a secret share stored on the device. The device and the peer devices may be edge devices. The encryption key is constructed from the secret shares using a Shamir's secret sharing algorithm. The quorum of the peer devices may be a simple majority or super majority of the peer devices. The quorum of the peer devices may be a fixed number or percentage of the peer devices, such as one, some, or all of the peer devices. The configuration change data may be one or more of an application update, a new application, an operating system update, a firmware change, a hardware change, or authentication credentials.

In another illustrative, non-limiting embodiment, a system comprises a central orchestrator configured to manage operation of edge devices; and a plurality of edge devices in communication with the central orchestrator. Each of the edge devices comprising a processor; and a memory coupled to the processor. The memory having program instructions stored thereon that, upon execution, cause the processor to receive configuration information from the central orchestrator, the configuration information associated with an encrypted token; send the configuration information to the other peer devices; receive secret shares from a quorum of the other edge devices, wherein each of the quorum of other edge devices sends its respective secret share if it determines that the configuration information complies with a configuration policy; construct an decryption key using a quorum of the secret shares; decrypt the encrypted token using the decryption key; and use the decrypted token to apply the configuration information on the edge device.

The program instructions, upon execution, further cause the processor to receive configuration information from a requesting edge device; determine whether the configuration information complies with a configuration policy; and send a secret share to the requesting edge device if the configuration information complies with a configuration policy. The decryption key is constructed from secret shares received from other edge devices using a Shamir's secret sharing algorithm. The quorum of the peer devices are a simple majority or super majority of the peer devices, or a fixed number or percentage of the peer devices, or all of the peer devices.

The configuration information is one or more of an application update, a new application, an operating system update, a firmware change, a hardware change, or authentication credentials.

In a further illustrative, non-limiting embodiment, a computer program product comprises a non-transient computer-readable storage medium that tangibly stores a set of machine-executable instructions that, when executed by a computing device, cause the computing device to receive configuration change instructions, the configuration instructions requiring an authentication key to install; send the configuration change instructions to a plurality of peer computing devices; receive secret shares from the peer devices, wherein each of peer devices sends its respective secret share it determines that the configuration change information complies with a configuration policy; construct the authentication key using the secret shares; and install the configuration change on the computing device using the authentication key. The set of machine-executable instructions further cause the computing device to determine whether the configuration change information complies with the configuration policy; and construct the authentication key using the received secret shares and a secret share stored on the computing device. A quorum of secret shares are required to construct the authentication key. The quorum of secret shares are received from a simple majority or super majority of the peer computing devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method for secure configuration change, comprising:
receiving configuration change data at a device, the configuration change data associated with an encrypted authentication key;
sending the configuration change data to a plurality of peer devices;
receiving secret shares from a quorum of the peer devices, wherein each of the quorum of peer devices sends its respective secret share if it determines that the configuration change data complies with a configuration policy;
constructing an decryption key using a quorum of the secret shares;
decrypting the authentication key using the decryption key; and
applying the authentication key to install the configuration change on the device.

2. The method of claim 1, further comprising:
determining, by the device, whether the configuration change data complies with the configuration policy; and
constructing the encryption key using the quorum of the secret shares and a secret share stored on the device.

3. The method of claim 1, wherein the device is an edge device.

4. The method of claim 1, wherein the device and the peer devices are edge devices.

5. The method of claim 1, wherein the encryption key is constructed from the secret shares using a Shamir's secret sharing algorithm.

6. The method of claim 1, wherein the quorum of the peer devices is a simple majority or super majority of the peer devices.

7. The method of claim 1, wherein the quorum of the peer devices is a fixed number or percentage of the peer devices.

8. The method of claim 1, wherein the quorum of the peer devices is all of the peer devices.

9. The method of claim 1, wherein the configuration change data is one or more of an application update, a new application, an operating system update, a firmware change, a hardware change, or authentication credentials.

10. A system, comprising:
a central orchestrator configured to manage operation of edge devices; and
a plurality of edge devices in communication with the central orchestrator, each of the edge devices comprising:
a processor; and
a memory coupled to the processor, the memory having program instructions stored thereon that, upon execution, cause the processor to:
receive configuration information from the central orchestrator, the configuration information associated with an encrypted token;
send the configuration information to the other peer devices;
receive secret shares from a quorum of the other edge devices, wherein each of the quorum of other edge devices sends its respective secret share if it determines that the configuration information complies with a configuration policy;
construct an decryption key using a quorum of the secret shares;
decrypt the encrypted token using the decryption key; and
use the decrypted token to apply the configuration information on the edge device.

11. The system of claim 10, wherein the program instructions, upon execution, further cause the processor to:
receive configuration information from a requesting edge device;
determine whether the configuration information complies with a configuration policy; and
send a secret share to the requesting edge device if the configuration information complies with a configuration policy.

12. The system of claim 10, wherein the decryption key is constructed from secret shares received from other edge devices using a Shamir's secret sharing algorithm.

13. The system of claim 10, wherein the quorum of the peer devices are received from a simple majority or super majority of the peer devices.

14. The system of claim 10, wherein the quorum of the peer devices are received from a fixed number or percentage of the peer devices.

15. The system of claim 10, wherein the quorum of the peer devices are received from all of the peer devices.

16. The method of claim 1, wherein the configuration information is one or more of an application update, a new application, an operating system update, a firmware change, a hardware change, or authentication credentials.

17. A computer program product comprising a non-transient computer-readable storage medium that tangibly stores a set of machine-executable instructions that, when executed by a computing device, cause the computing device to:
receive configuration change instructions, the configuration instructions requiring an authentication key to install;
send the configuration change instructions to a plurality of peer computing devices;
receive secret shares from the peer devices, wherein each of peer devices sends its respective secret share it determines that the configuration change information complies with a configuration policy;
construct the authentication key using the secret shares; and
install the configuration change on the computing device using the authentication key.

18. The computer program product of claim 17, wherein the set of machine-executable instructions further cause the computing device to:
determine whether the configuration change information complies with the configuration policy; and
construct the authentication key using the received secret shares and a secret share stored on the computing device.

19. The computer program product of claim 17, wherein a quorum of secret shares are required to construct the authentication key.

20. The computer program product of claim 19, wherein the quorum of secret shares are received from a simple majority or super majority of the peer computing devices.
